(19) United States
(12) Patent Application Publication
(10) Pub. No.: US 2005/0082329 A1
(43) Pub. Date: Apr. 21, 2005

(54) Bicycle carrier for motor vehicles

(76) Inventor: Simon Cohen, Diamond Bar, CA (US)

Correspondence Address: Averill & Varn, 8244 Painter Ave., Whittier, CA, 90602, US

(21) Appl. No.: 10/688,563

(22) Filed: Oct. 20, 2003

(51) Int. Cl. B60R 9/00; B60R 11/00

(52) U.S. Cl. 224/519; 224/924

(57) ABSTRACT

A bicycle carrier for supporting a bicycle with respect to a motor vehicle. The carrier has a rod having a conical or cylindrical portion. The conical or cylindrical portion of the rod is sized so that it fits snugly within the seat receptacle of the bicycle once the seat has been removed. A bicycle is supported on the carrier by removing the bicycle seat and placing the seat receptacle over the rod. Next, the seat receptacle is tightened onto the rod, securing the bicycle to the carrier.

### BACKGROUND OF THE INVENTION

The field of the invention is bicycle racks and the invention relates more particularly to bicycle racks which are affixable to motor vehicles or to trailers of motor vehicles. A myriad of styles of bicycle racks are commercially available since it is very common for a motorist to desire to transport a bicycle to a location where the bicycle can be ridden. A search revealed one patent which utilized a bicycle seat receptacle as a portion of a rack for supporting a bicycle. This is U.S. Pat. No. 4,219,142. This rack does not tighten a bicycle against a rod, but uses the rod together with a tie-down to hold the seat receptacle on one portion of the rack and a receptacle also with a tie-down to hold the goose neck portion of the bicycle to the rack.

Many racks require lifting the bicycle onto the roof of the motor vehicle. Other racks support only a single bicycle. Many racks require numerous fasteners to hold the bicycle onto the rack, and are thus time consuming to mount the bicycle onto the rack and to remove it from the rack.

### BRIEF SUMMARY OF THE INVENTION

The present invention is for a bicycle carrier for supporting a bicycle to a motor vehicle. A bicycle supporting rod having a conical and/or cylindrical portions is held to the vehicle. These portions may be tapered as in a conical version or stepped as in a cylindrical version. The present invention is also for the process of placing a bicycle onto the carrier. The process includes a step of removing the seat from the bicycle. The seat receptacle is then placed over the rod of the carrier and tightened against the rod to securely hold the bicycle to the rack.

### BRIEF DESCRIPTION OF THE SEVERAL VIEWS OF THE DRAWING

FIG. 1 is a perspective view showing the bicycle carrier of the present invention supporting a bicycle shown in phantom view.

FIG. 2 is an exploded perspective view of the bicycle carrier of the present invention.

FIG. 3 is a perspective view of a bracket which forms a portion of the carrier of FIG. 1.

FIG. 4 is a perspective view of a vertical structural member and a horizontal structural member of the bicycle carrier of FIG. 1.

FIG. 5 is an exploded perspective view of a square bent U-bolt which forms a portion of the carrier of FIG. 1.

FIG. 6 is an exploded perspective view of a conical rod and hollowed bracket of the bicycle carrier of FIG. 1.

FIG. 7 is an exploded perspective view of anti-wobble clamp bolt assembly which forms a portion of the carrier of FIG. 1.

FIG. 8 is a perspective view of an alternate embodiment of the bicycle carrier of FIG. 1.

FIG. 9 is a perspective view of an alternate embodiment of the bicycle carrier of FIG. 1.

FIG. 10 is a perspective view of an alternate embodiment of the bicycle carrier of the present invention.

### DETAILED DESCRIPTION OF THE INVENTION

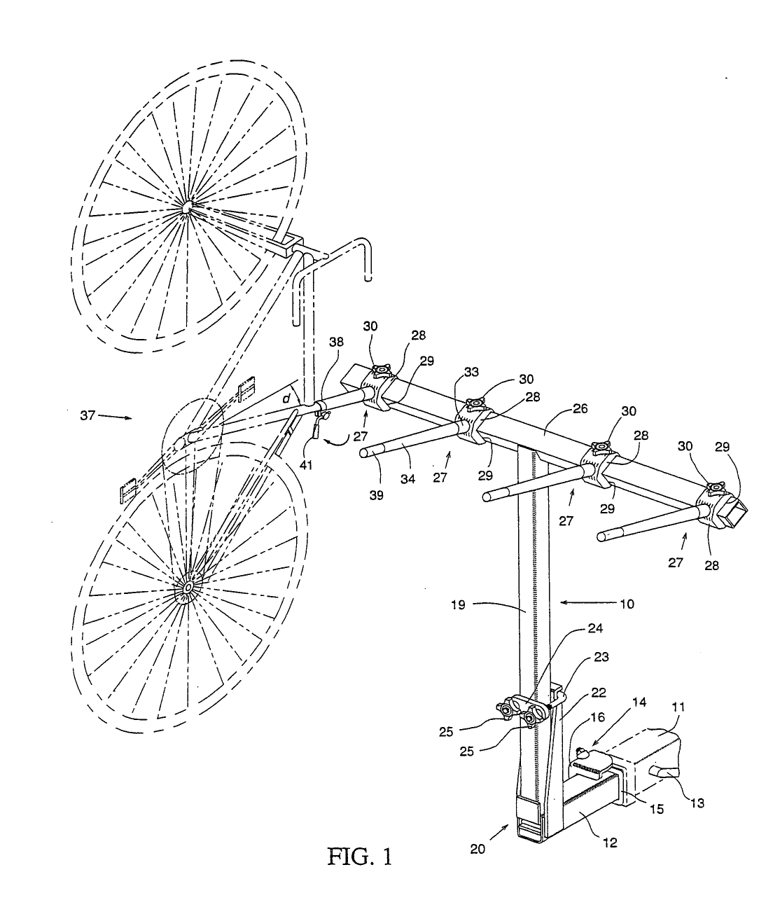

The bicycle carrier of the present invention is shown in perspective view in FIG. 1 and indicated generally by reference character 10. Carrier 10 is supported with respect to a motor vehicle (not shown) by a tow hitch receptacle 11 which holds a horizontal length of square tubing 12 by a conventional tow hitch pin 13.

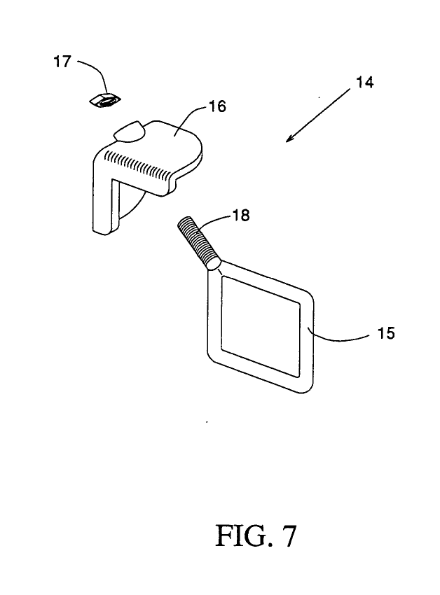

It has been beneficial, although not essential, that square tube 12 be supported in tow hitch receptacle 11 in a manner that prevents it from wobbling. This can be accomplished by use of an anti-wobble clamp assembly 14 shown in FIG. 7 of the drawings. This utilizes a square eye bolt 15 which is tightenable against square tube 12 and tow hitch receptacle 11 by an anti-wobble clamp bracket 16. A threaded nut 17 is screwed onto a threaded portion 18 of square eye bolt 15.

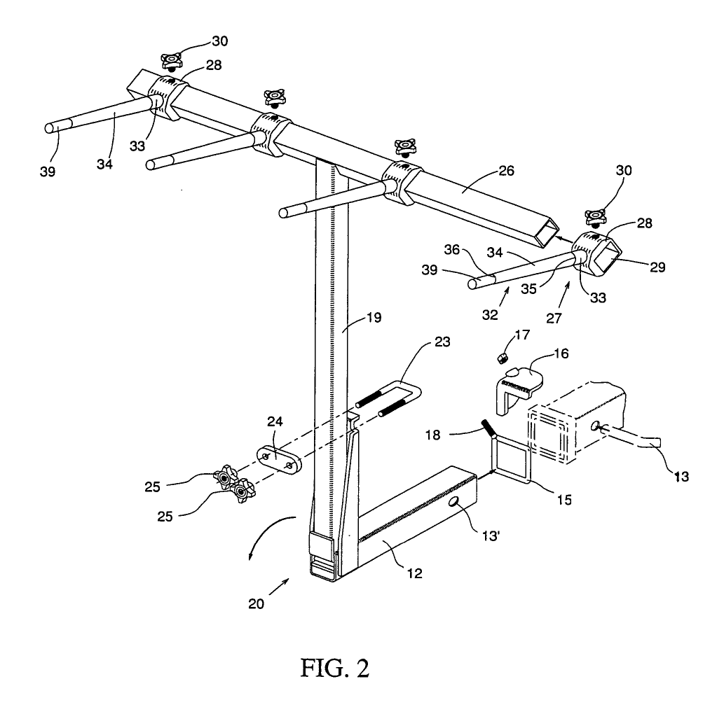

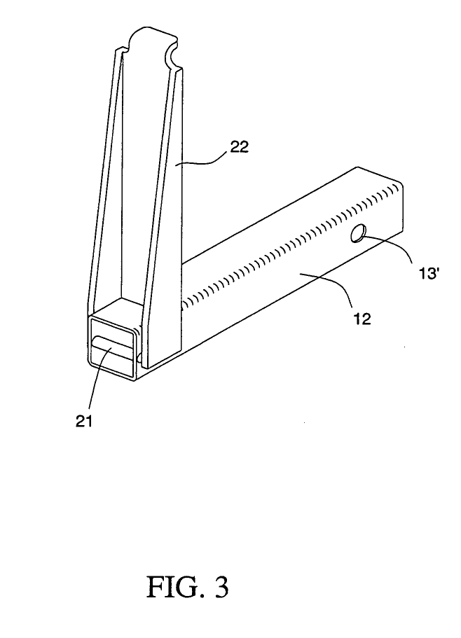

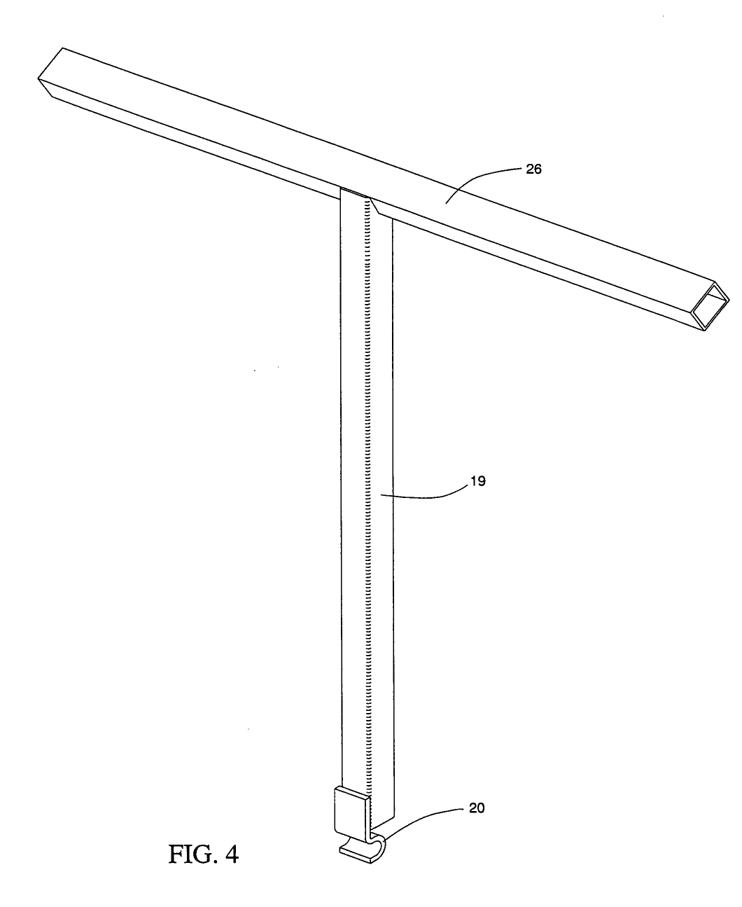

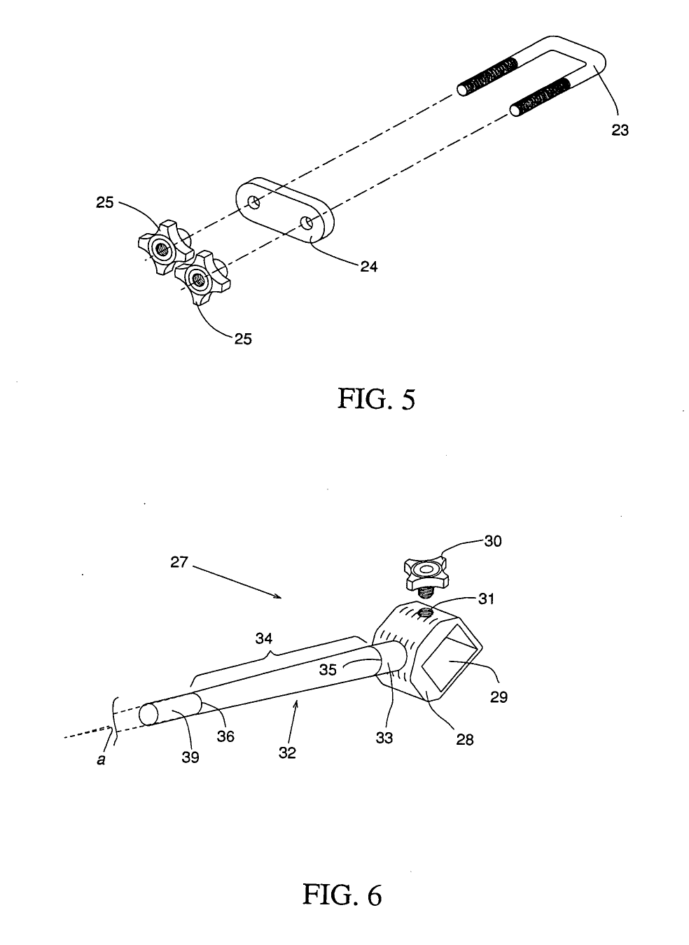

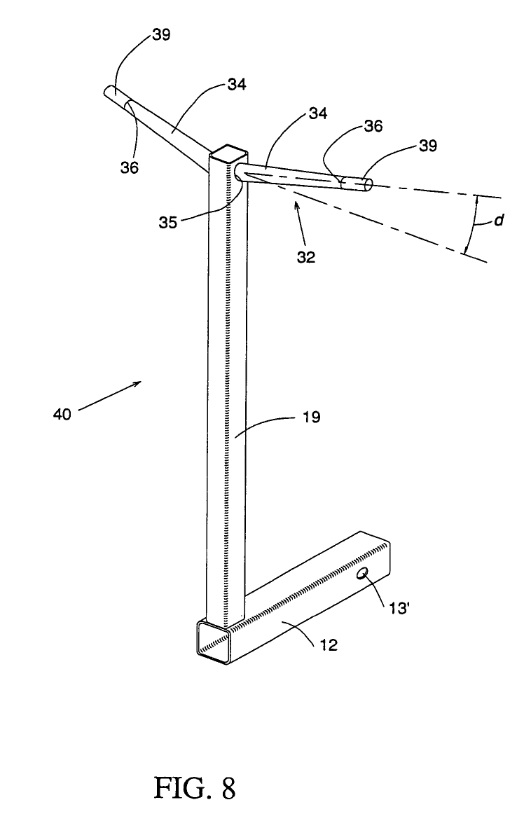

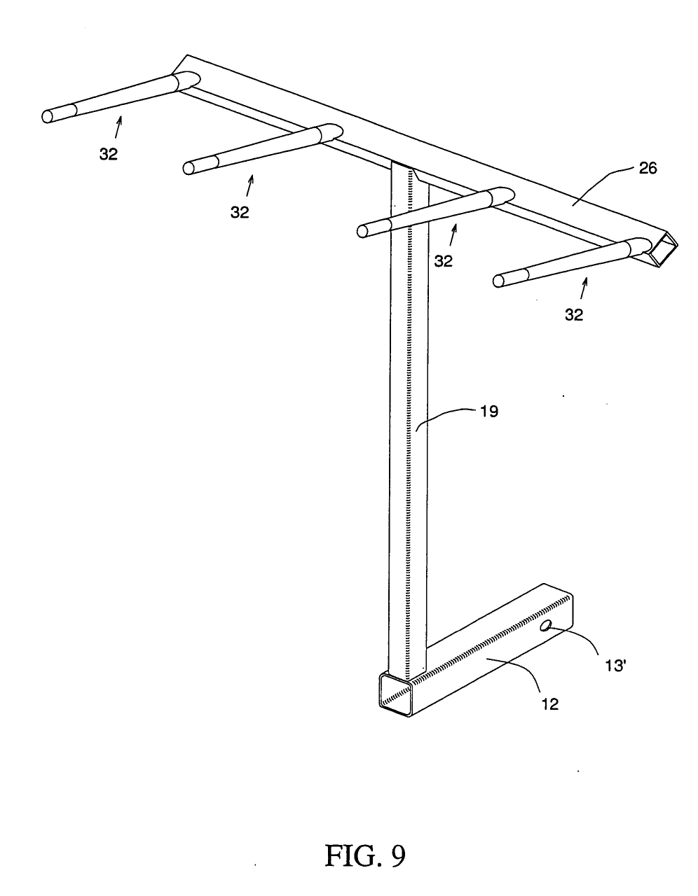

A generally vertical structural member 19 is held to square tube 12. Although not essential, it is beneficial that structural member 19 be removable from square tube 12 for storage and transportation of carrier 10. This can be accomplished by a hinged arrangement which utilizes a bent plate hinge 20 shown best in FIG. 4, which passes over a hinge pin 21 shown best in FIG. 3. Once the bent plate hinge 20 has been placed over hinge pin 21, the structural member 19 is moved into a vertical position as shown in FIG. 2. It is then clamped against a prop 22 and clamped thereto by square bent u-bolt 23. U-bolt 23 passes through a mounting plate 24 and is secured by two knobs 25 with threaded holes shown in FIG. 5. One benefit of the hinge assembly shown in FIG. 1 is that the vertical structural member 19 can be easily hinged downwardly to facilitate the opening of a back door of a vehicle. There are, of course, numerous other ways of supporting generally vertical structure member 19 to the tow hitch receptacle or to square tube 12. For instance, it maybe simply welded, as shown in FIG. 8 and FIG. 9.

As shown in FIGS. 1 and 2, a horizontal structural member 26 is welded or otherwise affixed to vertical member 19 for supporting bicycle carrying brackets 27. A particular design of a bicycle carrying bracket 27 is shown in exploded perspective view in FIG. 6. There it can be seen that a hollow bracket 28 has a square opening 29 which fits over structural member 26. A tightening knob 30 has a threaded portion which screws into a threaded hole 31.

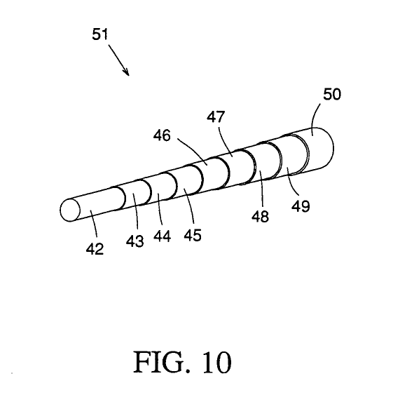

A bicycle carrying bar 32 is welded or otherwise affixed to hollow bracket 28. Bar 32 has a cylindrical portion 33 and a conical portion 34. Conical portion 34 has a widened end 35 and a narrowed end 36. Conical portion 34 is shown as a frusto conical portion having an angle at its conical apex indicated by the reference letter “a.” As shown in FIG. 1, a bicycle 37 has a bicycle seat receptacle 38 which has been placed over conical portion 34 of bicycle carrying bar 32. A short cylindrical set length 39 extends outwardly from narrowed end 36. This assists in guiding a bicycle seat receptacle onto the bicycle carrying bracket 27. A bicycle seat has been removed from bicycle 37 which leaves an open receptacle with a tightening knob 41 which is a part of bicycle 37. In some bicycles, a nut or other tightening device may be used. This is the portion of the bicycle which tightens the seat at the appropriate height and is invariably equipped to be loosened so that the seat height can be changed and tightened against the shaft of the seat assembly. The bicycle is actually held by gravity and the tightening step prevents movement and rattling, but is not essential for holding the bicycle on the rod. While frusto conical lengths have been emphasized above, the bicycle seat receptacle contacting portion may be of a stepped configuration as shown in FIG. 10. Rod 51 has a series of cylindrical steps 42, 43, 44, 45, 46, 47, 48, 49, and 50. The seat receptacle is pushed along rod 51 until it surrounds the largest step over which it will fit. The knob 41 is then tightened to secure the bicycle.

Once one reaches a destination and wishes to remove the bicycle, the knob 41 is loosened and the bicycle may be easily pulled out of contact with the bicycle carrying bar 32. The conventional bicycle seat is then replaced in bicycle seat receptacle 38. The configuration shown in FIG. 1 holds four bicycles and for many applications, it is preferred that a lesser number of bicycles be carried. A simplified bicycle carrier 40 for two bicycles is shown in FIG. 8. This has a square tube 12 with an opening 13′ for tow hitch pin 13. A generally vertical structural member 19 is welded to square tube 12. Two bicycle carrying bars 32 are welded or otherwise affixed near the top of generally vertical structural member 19. These bars, like the bars shown in FIGS. 1 and 2, are affixed at a slightly upward configuration from the horizontal. An angle indicated by reference letter “d” in FIG. 8 indicates this upward mounting. Angle “d” should be large enough to tend to urge the bicycle onto the tapered portion 34. Angle of about 15° is preferred, since this will keep bicycles vertical (front wheel above rear wheel), thus minimizing width of bicycle vertical projection.

With regard to specific dimensions, it has been found that a bicycle carrying bar 32 having a tapered cone apex angle of between about 2 and about 5 degrees and preferably about 3°, a small diameter of about 0.9″, a large diameter of about 1.2″, and a length of the tapered portion of 6″ has worked satisfactorily. The bicycle carrying bar or rod may be solid or hollow and may be mounted in a horizontal plane or as described above with the conical surface pointing upwardly. The bicycle carrying bar may be cylindrical for a particular size of bicycle. A tapered bar permits a wider range of bicycles to be secured to the bar.

The bicycle carrier of the present invention does not require the use of straps, brackets, or hooks and loops to hold and secure a bicycle to the carrier. The invention requires only a single fastener to secure and stabilize a bicycle to the bicycle carrier. That fastener is not part of the bicycle carrier, but is part of any conventional bicycle itself. It is inexpensive to manufacture, is easily attached to a conventional trailer hitch and may be easily removed when not needed.

Another advantage of the bicycle rack of the present invention is that any one bicycle can be removed in any order. Many bicycle racks stack the bicycles so that the outer bicycle must be removed first. Also, stacking bicycles tens to move the center of gravity further away from the vehicle. With the present invention, the center of gravity does not move outwardly with additional bicycles.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

1. A bicycle carrier for supporting a bicycle with respect to a motor vehicle, said bicycle having a seat receptacle with an inside diameter comprising:
a carrier frame supported on a motor vehicle;
a bicycle supporting rod having a bicycle seat receptacle contacting portion which has a narrow end and a wide end and said bicycle supporting rod being supported by said frame and oriented so that the narrow end is oriented outwardly from said carrier frame and said bicycle seat receptacle contacting portion having an outer periphery sufficiently small to fit within said seat receptacle and said wide end of said bicycle seat receptacle contacting portion being larger than said receptacle; and
means for supporting said frame on said vehicle.

2. The bicycle carrier of claim 1 wherein said bicycle seat receptacle contacting portion is frusto conical in shape and comprises a frusto conical portion.

3. The bicycle carrier of claim 2 wherein said frusto conical portion has a cone apex angle between about zero and five degrees.

4. The bicycle carrier of claim 3 wherein said cone apex angle is about three degrees.

5. The bicycle carrier of claim 1 wherein said bicycle seat receptacle contacting portion has a length of between four and seven inches.

6. The bicycle carrier of claim 5 wherein said bicycle seat receptacle contacting portion has a length of about six inches.

7. The bicycle carrier of claim 2 wherein said bicycle rod has a cylindrical length at a distal end of said bicycle support rod and an outside diameter of said cylindrical length is equal to an outside diameter of said narrowed end of said frusto conical portion.

8. The bicycle carrier of claim 1 wherein said carrier frame is supported by a tow hitch receptacle.

9. The bicycle carrier of claim 8 wherein said carrier frame has a length of square tubing supported by a tow hitch receptacle which length of square tubing supports a generally vertical structural member which supports a generally horizontal structural member which supports at least one bicycle supporting rod.

10. The bicycle carrier of claim 9 wherein said generally horizontal structural member supports a plurality of bicycle supporting rods.

11. The bicycle carrier of claim 9 wherein said at least one bicycle supporting rod is affixed to a collar which includes means for being clamped onto said generally horizontal structural member.

12. The bicycle carrier of claim 9 wherein said bicycle supporting rod is positioned at a slightly upward angle with respect to the horizontal.

13. The bicycle carrier of claim 12 wherein said angle is about 15 degrees.

14. The bicycle carrier of claim 8 wherein said carrier frame has a length of square tubing supported by the tow hitch receptacle which length of square tubing supports a generally vertical structural member which supports at least one bicycle supporting rod.

15. A process for transporting a bicycle on a motor vehicle said bicycle having a bicycle seat held in a bicycle seat receptacle, said process comprising:
affixing at least one bicycle supporting rod to a frame movable with a motor vehicle said bicycle supporting rod being affixed so that a distal end of said bicycle supporting rod points outwardly, said bicycle supporting rod having a bicycle seat receptacle contacting portion;
removing said bicycle seat from said bicycle seat receptacle;
inserting said bicycle seat receptacle over said bicycle seat receptacle contacting portion; and
tightening said seat receptacle against said bicycle supporting rod.

16. The process of claim 15 wherein said bicycle seat receptacle contacting portion has a narrowed portion smaller than said bicycle seat receptacle and a widened portion larger than said seat receptacle and said narrowed end being oriented outwardly and said inserting step includes moving said bicycle seat receptacle toward said widened portion until it will move inwardly no further.
